(19) United States
(12) Patent Application Publication
(10) Pub. No.: US 2006/0164987 A1
(43) Pub. Date: Jul. 27, 2006

(54) Adaptive dropping of prioritized transmission packets

(76) Inventors: Carles Ruiz Floriach, Mataro (ES); Yingwei Chen, Briarcliff Manor, NY (US); Jong Chul Ye, Croton-On-Hudson, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/521,249

(22) PCT Filed: Jul. 18, 2003
(86) PCT No.: PCT/US03/22510

§ 371 Date: Jan. 13, 2005

Related U.S. Application Data
(60) Provisional application No. 60/396,814, filed on Jul. 18, 2002.

(51) Int. Cl. H04J 1/16

(52) U.S. Cl. 370/235

(57) ABSTRACT

A series of information portions are provided to a transmitter, the information portions have critical times when they need to be available to a receiver. The transmitter estimates whether the information portions can be transmitted by the transmitter in time to be made available to the receiver before the critical time. Then the transmitter only transmits the information to the receiver if it is estimated that the information portions will be transmitted in time to be made available to the receiver before the critical time.

The invention is related to the field of transmission of media packets over a variable delay network such as the internet or a packet lossy network such as wireless LAN (local area networks) for real time presentation.

For real-time multimedia presentations such as MPEG encoded broadcast or live performances, each video and audio frame portion (frame or field) has a presentation time when the presentation of the frame portion needs to begin in order to provide continuous audio and video. In order to present the frame portion on time, each frame portion has a decoding time when all the packets of the frame portion must be available for transfer to the decoder for decoding of the frame portion.

Networks such as the internet or a wireless LAN tend to have variable bandwidths resulting in variable delays. If bandwidth becomes too constrained then packets fail to arrive in time and frames can not be decoded and presented on time. Typically for video, late frames are simply dropped and the previous frame repeated resulting in loss in the human perceived quality of the presentation.

For wireless LAN, delays and transmission failures are common and bandwidth varies. First, received signal power, hence channel throughput, decreases as the distance between the sender and the receiver increases. Second, collisions between two transmitters in the same wireless LAN network occur and are handled by random delays before retransmission. Third, packet errors occur due to random interference as well as interference from other devices emitting signals in the same frequency band. This is particularly observed in a 802.11b network, which uses the 2.4 GHz ISM band in which many other devices, such as microwave ovens, 2.4 GHz cordless phones, and other 802.11b networks, operate. For wireless LAN, not only are there packet delays due to the variable bandwidth, but often packets fail to be transmitted due to retransmission limits.

The MAC (media access) layer of an 802.11b receiver does not do any error correcting. If a packet fails the error checking of the receiver MAC layer, then the receiver does not send an acknowledgement and the MAC layer of the 802.11b transmitter re-sends the packet. The transmitter continues re-sending the packet until an acknowledgement is received or until a predetermined retransmission limit is reached.

It has been proposed to add error correction for media transmission through wireless LAN to reduce the need for retransmissions. One proposed error correction technique involves separating the audio/video information into two layers and sending these layers as different streams. One stream will contain the more-important information, and another stream will contain the less important information. More error protection is provided for the more important stream and less error protection is provided to the less important stream (this is called Unequal Error Protection). Although overhead is increased, the audio/video quality increases even more, so that for a given audio/video quality the overhead is actually less.

Another proposal is to transmit all the higher priority packets and drop all the lower priority packets when throughput is inadequate.

Those skilled in the art are directed to WO 01/65848 and WO 01/71981 and which are incorporated herein in whole. These references disclose schemes for splitting video streams into high and low priority streams and reducing the errors in the high priority stream with respect to the low priority stream.

In the invention, a series of information portions are provided to a transmitter, the information portions have critical times when they need to be available to a receiver. The transmitter estimates whether the information portions can be transmitted by the transmitter in time to be made available to the receiver before the critical time. Then the transmitter only transmits the information to the receiver if it is estimated that the information portions will be transmitted in time to be made available to the receiver before the critical time.

When the transmitter determines that bandwidth and delay requirements prevent all the information from being useful to the receiver then the transmitter drops the packets that will not be useful.

For example, in a video-layered solution, if the transmitter determines that the less important video information would not be useful (due to delay conditions and other requirements) then it is not transmitted at all. Even high priority packets may be dropped if all the high priority packets cannot be transmitted in time.

In the invention the transmitter has to be aware of the delay requirements of the video stream in order to predict whether transmission of packets will meet the delay requirements. The delay requirements may be standardized or the receiver needs to transmit an indication of the delay requirements to the transmitter.

There are two competing goals. First, the successful receipt of all base layer packets needs to be maximized. Second, the discarding of enhancement layer packets needs to be minimized. The proper balance between these goals increases throughput without substantially increasing overhead in the transmission. The invention balances these two goals so that the perceived quality of a presentation is increased with relation to the quality when trying to send all the packets.

Additional aspects and advantages of the invention will become readily apparent to those skilled in the art from the detailed description below with reference to the following drawings.

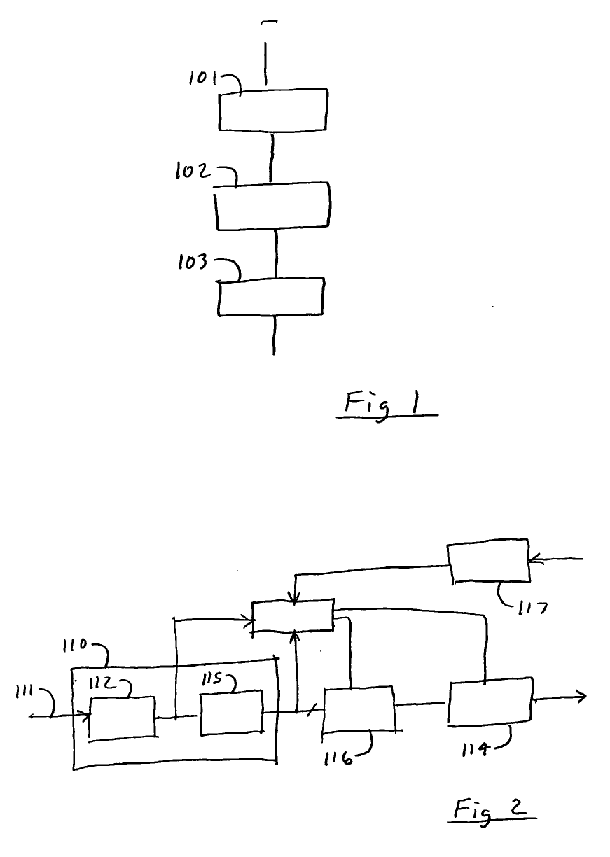

FIG. 1 illustrates the method of the invention.

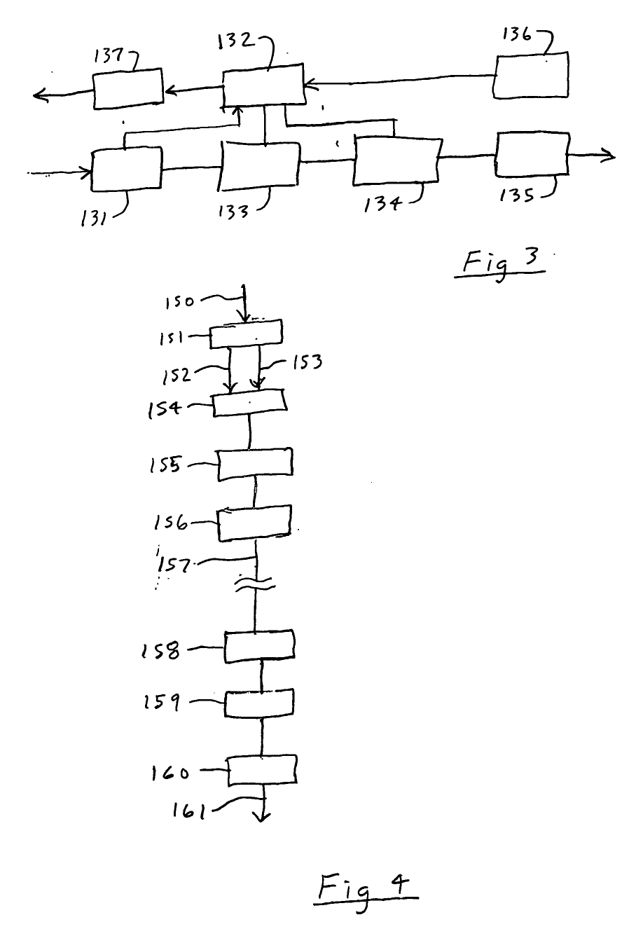

FIG. 2, shows relevant portions of an example transmitter of the invention.

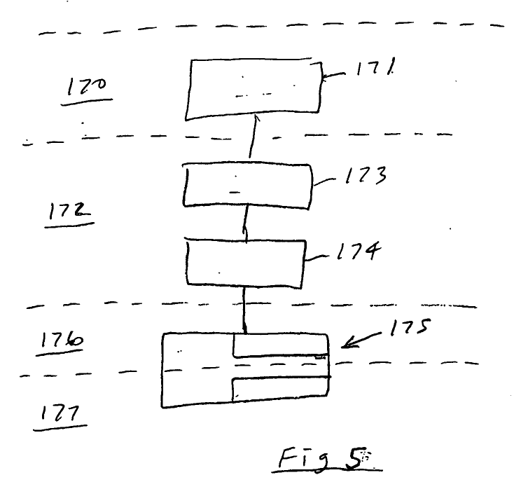

FIG. 3, shows relevant portions of an example receiver of the invention.

FIG. 4 illustrate some of the components of an example system of the invention.

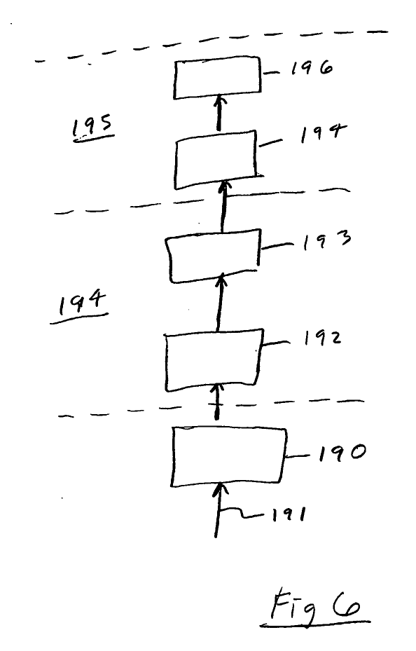

FIG. 5 shows the network stack of an example sender of the invention.

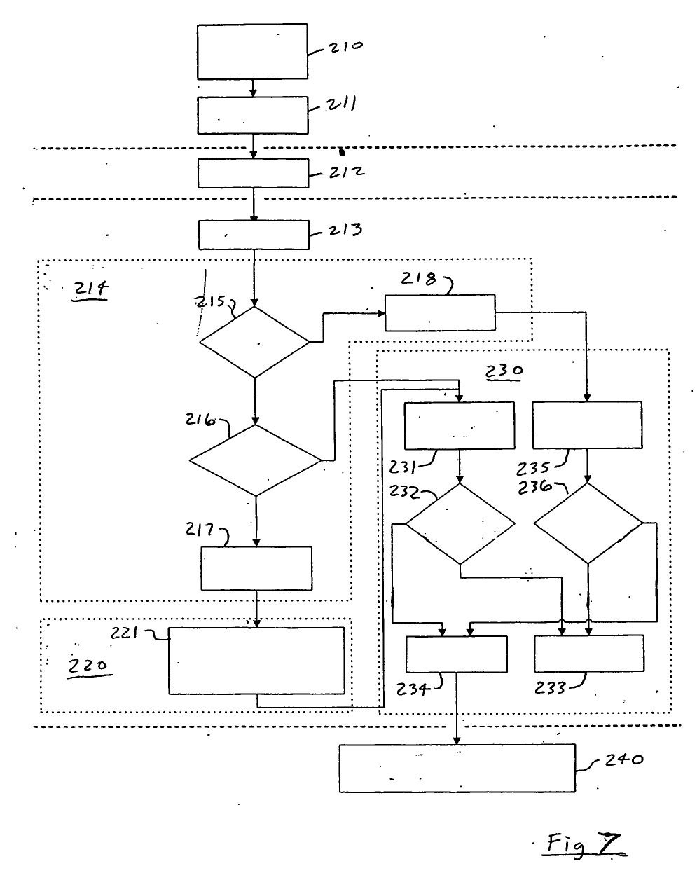

FIG. 6 depicts the structure of an example receiver of the invention.

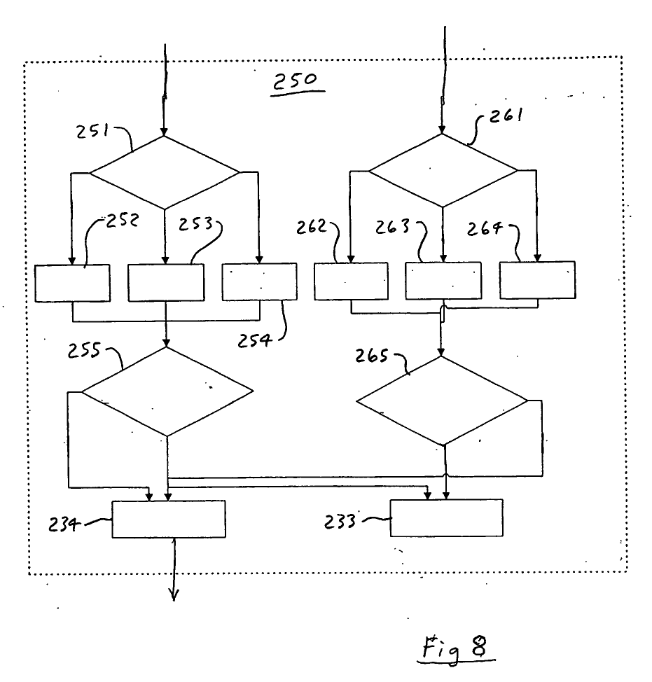

FIG. 7 illustrates an example algorithm of the invention for adaptively dropping prioritized packets.

FIG. 8 shows a variation of the decision module of the algorithm of FIG. 7.

FIG. 1 illustrates an example method of the invention. In step 101, a series of multiple information portions is provided to a transmitter. The information portions have critical times when they need to be available to a receiver. Each frame portion may have a presentation time and a decoding time when decoding needs to begin to guarantee that a decoded frame portion will be available at the presentation time, the decoding time and presentation time being relative to a playing time of the presentation.

The information portions may be packets of media frame portions (frames or fields of a frame) for a multimedia presentation. Such a presentation contains multiple frame portions and each frame portion contains multiple packets of media data.

Providing the information portions may include separating media information into high priority and low priority portions. The high priority portion may be a so called base layer that is required to decode the information portions and the low priority portion may be a so called enhancement layer that is used to enhance the decoded information portion.

For example, information portions for a media frame may include multiple high priority packets of the base layer and multiple low priority packets of the enhancement layer. All the high priority packets of the frame portion have to be available to the receiver in order to begin decoding the frame portion. If all the high priority packets are available, then whatever low priority packets are also available can be used by the decoder to enhance the frame portion. Packets with different priorities may be provided serially interleaved for a frame. Alternatively, all higher priority packets may be provided before providing any lower priority packets of a frame. This simplifies the determination of which packets to send if bandwidth is inadequate to send all the packets of the frame.

In step 102, the transmitter estimates whether the information portions can be transmitted in time to be made available to the receiver before the critical time.

The estimating may include determining a target time and estimating a transfer time and comparing the target time to the sum of a current time and the estimated transfer time. The target time is related to when an information portion needs to be available to the receiver for decoding the information portion (decoding time). The estimated transfer time is the time required for transmitting the information portion to the receiver and making the information portion available to the receiver for decoding the information portion.

The target time depends on the start-up buffering provided by the receiver. Receiver buffering is usually limited by a start-up limitation rather than by the cost of storage. Human viewers of presentations often object to start-up times exceeding a few seconds. Increasing the receiver buffering reduces the effects of short term restrictions on the throughput of the wireless channel. The receiver buffering may be standardized so the transmitter would know the buffer limits. Alternatively, the receiver can transmit the an indication of the buffering limits to the transmitter (e.g. start-up time, program play time, buffer size). For example, the viewer may input a start-up time preference depending on his aversion to slow start-up compared to his aversion to presentation quality degradations, and the receiver transmits the start-up preference to the transmitter.

The target time may be based on the time when an information portion is provided. For media frames, it can be assumed that packets of frames are provided as needed for decoding so its reasonable to base the target time on the time a packet was provided. Alternatively, the decoding time can be read from the packets of a media frame and used as a target time. Since all the high priority packets have to be at the decoder in order to begin decoding a frame, the target time can be the same for all the high priority packets of the frame. Also, typically all the low priority packets have to be available at the decoding time in order to enhance the frame. Thus, the target time may be derived from the time that the first portion of a frame is provided, and the same target time can be used for all the packets of the frame.

The estimation may depend on the priority of the information portions, so that higher priority information portions are more likely to be transmitted than lower priority information portions. For example, the target time or estimated transfer time for an information portion may be adjusted (by adding a factor or multiplying by a factor) depending on the priority of the information portion. For example, the target time may be calculated for a media frame, by adding the time when the first packet of the media frame arrives to the buffering time of the receiver. Different target times may be calculated for high and low priority frames by multiplying the buffering time by a delay tolerance which is higher for high priority packets and lower for low priority packets.

The information portions may be packets of a video presentation encoded based on a GOP (group of pictures) such as MPEG. In such encoding there are different types of video frames (frames or fields of frames) including I-frames that are decoded independent of the decoding of any other frame, and P-frames that are decoded based on the decoding of the previous I-frame, and B-frames that are decoded based in the previous and the following I or P-frame. Usually there are two B-frames for each P-frame. Thus, the I-frames are the most important frames because the decoding of all the other frames in a GOP is dependent on decoding the I-frame of the GOP. The P-frames are also important because the decoding of up to four B-frames depends on the decoding of each P-frame.

For GOP encoded video frames, the estimation may depend on the type of video frame. In a manor similar to that described above for packets with different priorities (base layer vs. enhancement layer packets).

The estimated transfer time can be fixed and based on the maximum packet size and retransmission limit. Alternatively, the estimated transmission time may be estimated dynamically, for example, based on retransmission counts when previous packets were transmitted. For example, an average transmission time of a previous predetermined number of packets can be used or the average can be a time weighted average in which more weight is assigned to more recently transmitted packets.

For variable size packets, the estimated transfer time of a packet may depend on the size of a packet. Larger packets take longer to transmit and tend to have more errors requiring more retransmissions. The adjustment for packet size can be predetermined or it can be based on averages or time weighted averages of a predetermined number of previous packets in the same size range.

In step 103, the packets are transmitted depending on the estimation. That is, packet which can be transmitted and processed by the receiver in time to be available at the critical time are transmitted and packets that can not be transmitted and processed by the receiver by the critical time are dropped.

For a media frame with packets having different priorities, all the higher priority packets of the frame can be transmitted prior to transmitting any lower priority packets. Alternatively, packets having different priorities can be transmitted interleaved as they are received. An advantage of transmitting higher priority packets earlier is that when bandwidth is reduced, the higher priority packets are automatically more likely to reach the receiver then the lower priority packets.

Typically in video encoding, all the packets of a frame portion must be available in order to decode a frame portion. In that case, if one packet of a frame portion is dropped, for example, because the retransmission limit is exhausted, then all the remaining packets of the frame portion may be dropped because they cannot be used by the receiver.

On the other hand, when the video information is separated into a base layer and an enhancement layer then only all the base layer packets are required to decode a frame portion. If an enhancement layer packet is dropped then any remaining base layer packets should still be transmitted.

The estimating may include multiple estimations during the transmission of packets of a media frame portion, whether all the packets of the media frame portion can be transmitted by the transmitter in time to be made available to the receiver before the critical time; and the transmitting depends on the multiple estimations for all the packets of the frame portion. Thus, when it is estimated that it is likely that some of the packets for the frame portion will not be transmitted in time, then the remaining packets for the frame portion are not transmitted.

When the information portions for a frame include information portions having different priorities, the estimating may include multiple estimations during the transmission of packets of a media frame portion, whether all the packets of the media frame portion of a priority can be transmitted by the transmitter in time to be made available to the receiver before the critical time, and the transmitting of packets of the same or lower priority depends on the multiple estimations for all the packets of the frame portion of the priority. Thus, when it is estimated that it is likely that some of the packets for the frame portion of the priority will not be transmitted in time for decoding the frame, then the remaining packets for the frame portion for the same or lower priority are not transmitted.

FIG. 2 shows relevant portions of an example of a transmitter of the invention. Source 110 provides a series of information portions that need be available to a receiver at critical times. The source may include an input 111 from an antenna or cable connection for receiving satellite or terrestrial broadcast signals. In addition or in the alternative to input 111, source 110 may include a source unit 112 which may include, for example, a hard drive, a media player such as a DVD player, or electronic storage unit; or the source unit may include a camera for capturing a live performance.

Controller 111 controls the operation of the transmitter including the transmission of the information portions to a receiver. The controller estimates whether the information portions can be transmitted by the transmitter in time to be made available to the receiver before the critical time.

Transmission unit 114 transmits the information portions to the receiver (shown below in FIG. 3) depending on the estimating. The controller sends a control signal to the transmission unit to transmit an information portion. That is, the information portions are only transmitted by the transmitter unit if the information portions are likely to be made available to the receiver before the critical time.

The information portions may include high priority and low priority information portions or source 110 may contain a partitioner 115 to separate provided information into high priority information portions and low priority information portions.

Buffer 116 is provided to store the information portions and allow processing of the information portions by the controller. For example, partitioner 115 may packetize the information into serially interleaved high priority packets and low priority packets which are stored in the buffer, and then the controller controls the buffer to send all the high priority packets to the transmitter before sending any of the low priority packets to the transmitter.

Receiver unit 117 receives control information from the receiver (shown below in FIG. 3). Such information may include a request to receive the information portions and information indicating the start-up time (buffer limit) of the receiver of FIG. 3.

FIG. 3 illustrates relevant portions of an example receiver of the invention. Receiver unit 131 receives the information portions. Controller 132 controls a buffer 133 to buffer the information portions and at critical times, to send the information portions to decoder 134. Buffer 133 will store information portions for a length of time up to a start-up delay time, and then pass the information portions to decoder 134. For example, when the information portions include encoded video information then at a decoding time the decoder receives the information portions for a frame portion and at a presentation time the decoder provides the decoded frame portion to video display 135. During a presentation, video frames are normally displayed at a constant predetermined frame rate, but decoding time may vary depending on frame type, frame size, and frame complexity.

User input 136 may be used to initiate reception of information portions and may be used to select a start-up delay. Controller 132 controls transmission unit 137 to transmit the request to receive information portions and the start-up delay of the receiver to the transmitter of FIG. 2.

The following describes an example system of the invention. A layered multimedia streaming system is implemented using a client-server model. The encoded bit stream has several layers including a base layer that is required to decode video stream and enhancement layers that are used to enhance the decoding. An application operating on the client initiates a streaming session by sending a request to the server to start transmitting. The protocol used to exchange management information may be RTSP (Real Time Streaming Protocol). The server responds by transmitting a data stream to the client. The protocol used for the data stream is RTP (Real Time Protocol). RTSP streams rely on TCP (Transmission Control Protocol) as the transport protocol while RTP streams employ UDP (User Data Protocol). IP (internet protocol) is the protocol used at the network layer, and the link layer uses IEEE 802.11 wireless technology.

In FIG. 4, a broadcast information stream is received at 150 and separated by partitioner 151 into a base layer stream 152 and enhancement layer stream 153. A streaming server 154 passes the base and enhancement layer streams to a MAC (Media Access) layer 155 communicating through a wireless transmitter 156. The base and enhancement streams travel through the wireless medium 157 to wireless receiver 158. Then the base and enhancement streams are passed to a client application 159 which provides them to a decoder 160 which merges the streams and decodes them to provide a decoded multimedia presentation at 161.

FIG. 5 illustrates parts of the sender network stack. In an application layer 170, a video streaming server 171 provides a layered multimedia stream. The main tasks of the streaming server are to build RTP packets and to manage the streaming session (including packet scheduling). The server bases its operation on the hinting information available in the video file. The server reads the hinting information and creates two streams of RTP packets. One stream contains base layer packets and the other stream contains the enhancement layer packets. Each packet includes an RTP payload field and the RTP payload field values of the base layer packets are different from the RTP payload field values of the enhancement layer packets. Thus, the base layer packets can be distinguished from the enhancement layer packets based on their different values for the RTP payload field.

The server also adds an RTP timestamp to each packet. The value of the RTP timestamp is the same for all the packets of a frame, and indicates the time when the packet was created.

The streaming server delivers the streams to an operating system kernel 173 using a UDP socket. At certain instants the server forewords all packets corresponding to the same video frame to the system kernel. First the server sends all the base layer (high priority) packets for the frame and then the server sends all the enhancement layer (low priority) packets for the frame. Thus, the streams are forwarded in alternating cycles of base and enhancement layer packets. The system Kernel passes the streams to an 802.11 device driver 174. Operating system Kernel 173 and 802.11 device driver 174 are portions of an operating system layer. The 802.11 device driver passes the streams to an wireless transmission device 175 that includes an 802.11 MAC layer 176 and an 802.11 physical layer 177 for radio frequency (RF) wireless transmission.

Since the system server (as described above) sends alternating cycles of base and enhancement layer packets, and the base and enhancement layer packets have different values in their RTP payload fields, the beginning of a frame is easily detected. An alternative way to detect frame boundaries is to use the RTP timestamp since it has the same value for all the packets of a frame and different value from the packets of adjacent frames.

Sending the base layer packets first is a good way to prioritize their transmission to the detriment of the enhancement layer packets. After the base layer packets are all successfully sent we can decide whether to drop enhancement layer packets depending on delay limitations and on system conditions.

FIG. 6 illustrates the structure of an example receiver of the invention. Packets are received by a 802.11 network device 190 through a wireless link at 191. The packets are passed from the 802.11 network device 190 through 802.11 device driver 192 and through operating system kernel 193. 802.11 device driver 192 and through operating system kernel 193 are parts of the operating system layer 194 of the receiver. Then the packets are passed from operating system kernel 193 into client buffer 195 of client application layer 195. The RTP timestamp is used to identify which packets belong to a particular frame. At a decoding time for the frame, all the packets for the frame are passed to decoder 196.

FIG. 7 illustrates an example algorithm of the invention for adaptively dropping prioritized packets. The dashed horizontal lines separate steps that are performed in different portions of the server. In step 210, a streaming video server creates the base layer and enhancement layer packets and in step 211 the server timestamps all the packets for a frame with a timestamp time and sends all the packets for the frame to an operating system kernel. The server sends all the base layer packets for a frame before sending any of the enhancement layer packets for the frame. In step 212, the packets for the frame are stored in socket buffering of the system kernel. In step 213, the 802.11 device driver reads a packet type.

In a detection module 214 which detects the packet type and whether the packet is the start of a new video frame. In the detection module, in step 215, the driver determines whether the packet is a base layer packet. If the packet is a base layer packet then in step 216 the driver determines whether the driver is already in a base layer cycle state. If the driver is not in the base layer cycle state then this is the first packet of a frame and in step 217 the driver enters the base layer cycle state. Also, in detection module 214, if in step 215 its determined that the packet is not a base layer packet, then the packet is an enhancement layer packet and in step 218 the driver is in an enhancement layer state.

In the target time module 220 for estimating target time, at the beginning of the transmission of a new frame, the driver estimates a target time which is the latest time that any packet of the frame should arrive at the receiver. In the target time module, in step 221, a target time for base layer packets and a different target time for enhancement layer packets is calculated. The target time for base layer packets is the sum of the RTP timestamp time of the first packet of the frame and the buffering time of the receiver multiplied by a delay tolerance for base layer packets. The target time for enhancement layer packets is the sum of the RTP timestamp time of the first packet of the frame and the buffering time of the receiver multiplied by a delay tolerance for enhancement layer packets.

The delay tolerance for base layer packets should be much greater than the delay tolerance for enhancement layer packets. The values of these delay tolerances may be constant or they may be tuned depending on the specific application, the specific network, and on network conditions.

The buffering time of the receiver is essentially the start-up delay for the stream in the receiver. This may be a predetermined fixed amount. Alternatively, the buffering time may be a variable amount that has to be received from the receiver. The transmission of the buffering time can be done using RTSP (real time streaming protocol), which was also the protocol used by the receiver to initiate the streaming session.

In this embodiment, the same base layer target time is used for all the base layer packets and the same enhancement layer target time is used by all the enhancement layer packets.

The adjustment of these delay tolerances may be used to balance the two competing goals in the transmission of media packets to maximize perceived quality. The first goal is to maximize the successful receipt of all base layer packets. The second goal is to minimize the discarding of enhancement layer packets.

The above calculation of the target times for base and enhancement layer packets is based on the RTP timestamp time of the first packet of the frame. Another alternative is to use the frame rate to estimate the decoding time. However the RTP timestamp time and the frame rate are not accurate indicators of the decoding time—which is the true target time. However, the decoding time can be derived from the RTP time, and then the decoding time can be used in the calculation of the target time for a frame.

In a decision module 230 that decides whether to transmit packets, the driver estimates the transmission duration of each packet and decides whether to transmit the packet or not depending on the target time for the type of packet that was determined in the target time module in step 221. In the decision module, if the packet is a base layer packet then in step 231, the transfer time of the base layer packet is estimated.

The average transfer time of the packet may be derived based on network conditions and the size of the packet. A time weighted average can be used for network conditions. Alternately, actual network conditions may be ignored and worst case conditions used. In that case transfer time is fixed and does not need to be calculated. Worst case transfer time can be based on the maximum retransmission limit for the type of packet and the maximum packet size. The retransmission limit may be higher for base layer packets than for enhancement layer packets. A typical maximum packet size for video packets in 802.11 wireless transmission is 1500 bytes.

In step 232, the driver determines whether the sum of the current time and the transfer time exceeds the target time for the base layer packet. If the target time in step 232 is exceeded, then in step 233 the base layer packet is dropped. Since the target time is the same for all the base layer packets of the same frame then this means that all the following base layer packets will also be dropped. Also, the target time for all the following enhancement layer packets of the frame will be the same and will be lower so that all the following enhancement layer packets of the same frame will also be dropped.

Otherwise in step 232 if the target time is not exceeded then in step 234, the base layer packet is sent to the 802.11 device.

In the decision module, if the packet is an enhancement layer packet, then in step 235, the transfer time of the enhancement layer packet is estimated. The above discussion of estimating of the transfer time for base layer packets is also generally applicable to the estimating of the transfer time of enhancement layer packets.

In step 236, the driver determines whether the sum of the current time and the transfer time exceeds the target time for the enhancement layer packet. If the target time in step 236 is exceeded, then in step 233 the enhancement layer packet is dropped. Since the target time is the same for all the enhancement layer packets of the same frame then this means that all the following enhancement layer packets will also be dropped.

Otherwise in step 236 if the target time is not exceeded then in step 234, the enhancement layer packet is sent to the 802.11 device.

In step 240, the 802.11 device stores the packet to be transferred in the MAC buffer, and then transmits the packet. If no ACK is received, then the packet is retransmitted until either an ACK is received or the retransmission limit is exhausted.

FIG. 8 shows a modification of the decision module 230 of the algorithm of FIG. 7. In the algorithm of FIG. 8, the determination of whether to transmit or drop frames depends on the frame type. In modified decision module 250, if the packet is a base layer packet, then in step 251 a frame type is determined. If the frame type is an I-frame, then in step 252 a tolerance is set to an I-frame tolerance value for base layer packets for I-frames. Otherwise, if the frame type is an P-frame, then in step 253 the tolerance is set to an P-frame tolerance value for base layer packets for P-frames. Otherwise, if the frame type is an B-frame, then in step 254 the tolerance is set to a B-frame tolerance value for base layer packets for B-frames. The tolerance value for I frames should be larger than the tolerance value for P-frames or B-frames. The tolerance value for B-frames should be, for example, zero.

In step 255, the driver determines whether the sum of the current time and the transfer time exceeds the sum of the target time and the tolerance for the base layer packet. If the sum of the target time and the tolerance in step 255 is exceeded, then in step 233 the base layer packet is dropped. Otherwise in step 255 if the sum of the target time and the tolerance is not exceeded then in step 234, the base layer packet is sent to the 802.11 device.

In modified decision module 250, if the packet is an enhancement layer packet, then in step 261 a frame type is determined. If the frame type is an I-frame, then in step 262 a tolerance is set to an I-frame tolerance value for enhancement layer packets for I-frames. Otherwise, if the frame type is an P-frame, then in step 263 the tolerance is set to an P-frame tolerance value for enhancement layer packets for P-frames. Otherwise, if the frame type is an B-frame, then in step 264 the tolerance is set to a B-frame tolerance value for enhancement layer packets for B-frames. Again, the tolerance value for I frames should be larger than the tolerance value for P-frames or B-frames. The tolerance value for B-frames should be, for example, zero.

In step 265, the driver determines whether the sum of the current time and the transfer time exceeds the sum of the target time and the tolerance for the enhancement layer packet. If the sum of the target time and the tolerance in step 255 is exceeded, then in step 233 the enhancement layer packet is dropped. Otherwise in step 255 if the sum of the target time and the tolerance is not exceeded then in step 234, the enhancement layer packet is sent to the 802.11 device.

The invention has been described above in relation to specific example embodiments. Those skilled in the art will know how to modify these example embodiments within the scope of the invention herein. The invention is only limited by the following claims.

1. A method comprising:
providing a series of information portions to a transmitter, the information portions having critical times when they need to be available to a receiver;
estimating whether the information portions can be transmitted by the transmitter in time to be made available to the receiver before the critical time; and
transmitting the information portions to the receiver depending on the estimating.

2. The method of claim 1, wherein the information portions are packets of media frame portions for a multimedia presentation, the presentation including multiple frame portions each frame portion including multiple high priority packets and multiple low priority packets.

3. The method of claim 2, wherein the multiple frame portions each have a decoding time before which all the high priority packets of the frame portion need to be available to the receiver to decode the frame portion in time for presentation at a predetermined presentation time of the frame portion, the decoding time and presentation time being relative to a playing time of the presentation.

4. The method of claim 3, wherein the low priority packets are used to enhance the frame portion during decoding when some but not all of the low priority packets are not available to the receiver at the critical time.

5. The method of claim 1, wherein providing the information portions includes separating information into information portions having different priorities.

6. The method of claim 1, in which providing the information portions includes providing media frame portions and partitioning each frame portion into high priority information portions that are necessary to decode the frame portion and low priority information portions that are only needed to enhance the frame portions.

7. The method of claim 1, wherein the information portions include high priority and low priority packets of media frame portions and all the high priority packets for one frame portion are provided before any low priority packets for the frame portion are provided.

8. The method of claim 1, wherein: the estimating includes determining a target time when one information portion needs to be available to the receiver and determining an estimated transfer time for transmitting the information portion and making the information portion available to the receiver; the estimating includes determining whether the target time exceeds the sum of the estimated transfer time plus the current time of the transmission; and the information portion is transmitted depending on the determination.

9. The method of claim 1, wherein the estimating depends on a buffering limit of the receiver.

10. The method of claim 9, wherein the receiver transmits an indication of the buffering limit to the transmitter.

11. The method of claim 1, wherein the estimating depends on a priority of the information portion being transmitted.

12. The method of claim 8, wherein the information portions include high priority packets and low priority packets and the target time depends on a predetermined delay tolerance that is larger for the high priority packets than for the low priority packets so that the high priority packets are more likely to be received by the receiver than the low priority packets.

13. The method of claim 1, wherein the information portions are packets of media frame portions and the estimating depends on a type of media frame of the packet.

14. The method of claim 8, wherein:
the information portions are portions of a video presentation encoded based on a group of pictures of different types of video frames including I-frames that are decoded independent of the decoding of any other frame, and P-frames that are decoded based on the decoding of the previous I or P-frame, and B-frames that are decoded based in the previous and the following I or P-frame; and
the target time depends on the type of video frame.

15. The method of claim 1, wherein the information portions are packets of media frame portions and the estimating depends on a decoding time of the media frame portion of the information portion to be transmitted.

16. The method of claim 8, wherein the information portions are packets of media frame portions of a presentation, multiple media frame portions each having a decoding time when packets of the frame portion have to be available at a decoder of the receiver for decoding in time for presentation at a predetermined presentation time of the frame portion, the target time of one information portion depending on the decoding time of the frame portion of the information portion, the decoding time and presentation time of a frame portion being relative to a play time of the presentation.

17. The method of claim 1, wherein the estimating depends on the maximum size on an information portions.

18. The method of claim 1, wherein the transmission includes retransmitting information portions until a predetermined limit on the number of retransmissions is reached or an acknowledgement is received from the receiver that the portion has been successfully received without any uncorrectable errors, and the estimating depends on the retransmission limit.

19. The method of claim 1, wherein the estimating depends on the actual transfer time of previously transmitted information portions.

20. The method of claim 1, wherein the information portions are high priority and low priority packets of media frame portions and transmitting all the high priority packets for one frame portion begins before the beginning of transmitting the low priority packets for the frame portion.

21. The method of claim 1, wherein transmitting the information portions depends on whether previous information portions were successfully transmitted.

22. The method of claim 1, wherein the information portions have different priorities and transmitting the information portions depends on whether previous information portions with the same or higher priority were successfully transmitted.

23. The method of claim 1, wherein the information portions are high priority and low priority packets of media frame portions and transmitting the high priority packets depends on whether previous high priority packets for the same frame portion have been transmitted and transmitting the low priority packets depends on whether previous high priority and previous low priority packets for the same frame portion have been transmitted.

24. The method of claim 1, wherein the method further comprises receiving a request from the receiver to initiate transmitting the information portions to the receiver.

25. The method of claim 2, wherein the estimating includes multiple estimations during the transmission of packets of a media frame portion, whether all the packets of the media frame portion can be transmitted by the transmitter in time to be made available to the receiver before the critical time, and the transmitting depends on the multiple estimations for all the packets of the frame portion so that when it is estimated that it is likely that some of the packets for the frame portion will not be transmitted in time, then the remaining packets for the frame portion are not transmitted.

26. The method of claim 2, wherein the information portions for a frame include information portions having different priorities, the estimating includes multiple estimations during the transmission of packets of a media frame portion, whether all the packets of the media frame portion of a priority can be transmitted by the transmitter in time to be made available to the receiver before the critical time, and the transmitting of packets of the same or lower priority depends on the multiple estimations for all the packets of the frame portion of the priority so that when it is estimated that it is likely that some of the packets for the frame portion of the priority will not be transmitted in time, then the remaining packets for the frame portion for the same or lower priority are not transmitted.

27. A method comprising:
separating a media stream for a performance into multiple media streams with different priorities for transmission over a network having a variable conditions, the media stream having a predetermined schedule;
determining whether to transmit portions of the multiple media streams depending on the priorities and on the network conditions so that the perceived quality of the performance is increased relative to attempting to transmit all of the multiple media streams; and
transmitting the portions of the multiple media streams depending on the determination.

28. The method of claim 27, wherein the network is a wireless network and packets are transmitted serially, and each packet is transmitted and retransmitted until an acknowledgement is received or a retransmission limit is reached.

29. A transmitter for transmitting information portions to a receiver, comprising:
means for providing a series of information portions that need be available to the receiver at critical times;
means for estimating whether the information portions can be transmitted by the transmitter in time to be made available to the receiver before the critical time; and
transmitting apparatus to transmit the information portions to the receiver depending on the estimating.

30. The transmitter of claim 29, wherein:
the transmitter further comprises means for receiving an indication of the size of buffering from the receiver; and
the estimating depends on the indication of the size of buffering in the receiver.

31. The transmitter of claim 29, wherein:
the transmitter further comprises means for determining a decoding time of the information portions; and
the estimating depends on the decoding time of the information portions.

32. The transmitter of claim 29, wherein:
the means for providing information portions includes means for partitioning information into information portions having different priorities; and
the estimating depends on the priorities of the information portions.

33. A receiver comprising:
means for requesting a transmitter to transmit information portions that have to be available to the receiver at critical times;
means for buffering information portions that arrive before the critical time; and
means for transmitting an indication of the size of the buffering to the transmitter.

34. The receiver of claim 33, wherein:
the information portions are packets for encoded media frames, each of multiple media frames containing multiple packets;
the receiver further comprises a buffer for storing the packets and means for decoding the packets at the critical time;
all the packets for a frame contain the same timestamp; and
all the packets for a frame are identified based on the same timestamp and transferred together to the decoder.

35. The receiver of claim 33, wherein:
the information portions are packets for encoded media frames, each of multiple media frames containing multiple packets;
the receiver further comprises a buffer for storing the packets and means for decoding the packets at the critical time;
the packets include high priority packets and low priority packets;
all the packets contain an indication of their priority;
the high priority packets for a frame are received before the low priority packets for the frame are received; and
all the packets for a frame are identified by the changes in the indication of packet priorities and transferred together to the decoder.
